(19) United States
(12) Patent Application Publication
(10) Pub. No.: US 2020/0051153 A1
(43) Pub. Date: Feb. 13, 2020

(54) COMPARATIVE RANKING SYSTEM

(71) Applicant: CarGurus, Inc., Cambridge, MA (US)

(72) Inventors: Oliver I. Chrzan, Somerville, MA (US); Stephen H. Chan, Quincy, MA (US)

(21) Appl. No.: 16/100,568

(22) Filed: Aug. 10, 2018

(51) Int. Cl. G06Q 30/06; G06Q 30/02; G06F 17/30

(52) U.S. Cl. CPC G06Q 30/0629; G06F 17/30958; G06Q 30/0627; G06Q 30/0282

(57) ABSTRACT

A combination of match-based and graph-based scoring techniques are used to derive accurate relative rankings for a number of similar vehicles or other items based on user input. The resulting ranking system can advantageously provide meaningful feedback to consumers, even in the presence of large variations in the number and mix of side-by-side comparisons. This scoring engine can be further improved through techniques such as limiting feedback to binary choices in a side-by-side comparison between two specific items, and preconditioning the receipt of user input on a user assertion of first-hand knowledge of the items being compared.

### BACKGROUND

A variety of platforms gather and collate consumer ratings of restaurants, hotels, vehicles and so forth. Unfortunately, the absence of consistent calibration or normalization of quantitative evaluations typically causes aggregated ratings to tend toward a mean, such as three and one half stars. Additionally, overall ratings can obscure large differences among individual features. For example, a consumer may respond broadly to a non-specific request for evaluation of a vehicle without making concrete comparisons to similar vehicles based on particular features such as handling, comfort, cargo capacity, seating, fuel economy and so forth. As a result, rankings based on this feedback often fail to provide meaningful quantitative distinctions, and new customers may find it difficult to select among similar offerings according to relative merit.

There remains a need for improved techniques for ranking products such as vehicles relative to one another based on user feedback.

### SUMMARY

A combination of match-based and graph-based scoring techniques are used to derive accurate relative rankings for a number of similar vehicles or other items based on user input. The resulting ranking system can advantageously provide meaningful feedback to consumers, even in the presence of large variations in the number and mix of side-by-side comparisons. This scoring engine can be further improved through techniques such as limiting feedback to binary choices in a side-by-side comparison between two specific items, and preconditioning the receipt of user input on a user assertion of first-hand knowledge of the items being compared.

### BRIEF DESCRIPTION OF THE FIGURES

The invention and the following detailed description of certain embodiments thereof may be understood by reference to the following figures:

FIG. 1 shows entities participating in a ranking system.

FIG. 2 is a flow chart of a method for comparing vehicles.

FIG. 3 shows a graph for scoring vehicles.

FIG. 4 shows a web page for acquiring comparison data.

FIG. 5 shows a web page for presenting ranked results.

### DETAILED DESCRIPTION

All documents mentioned herein are incorporated by reference in their entirety. References to items in the singular should be understood to include items in the plural, and vice versa, unless explicitly stated or otherwise clear from the context. Grammatical conjunctions are intended to express any and all disjunctive and conjunctive combinations of conjoined clauses, sentences, words, and the like, unless otherwise stated or clear from the context. Thus the term “or” should generally be understood to mean “and/or” and so forth.

The following description emphasizes techniques for ranking automobiles based on user feedback. However, it should be understood that the methods and systems described herein may be applied to other vehicles such as motorcycles, sport utility vehicles, light trucks, trucks, and the like, and that the methods and systems may also or instead be readily adapted to ranking of other types of goods and services including, without limitation, hotels, vacation accommodations, airline tickets, live event seating, software, consumer electronics, packaged goods, professional services and so forth. More generally the methods and systems disclosed herein may be usefully employed in any context where rankings might usefully be provided among similar items that are offered for sale.

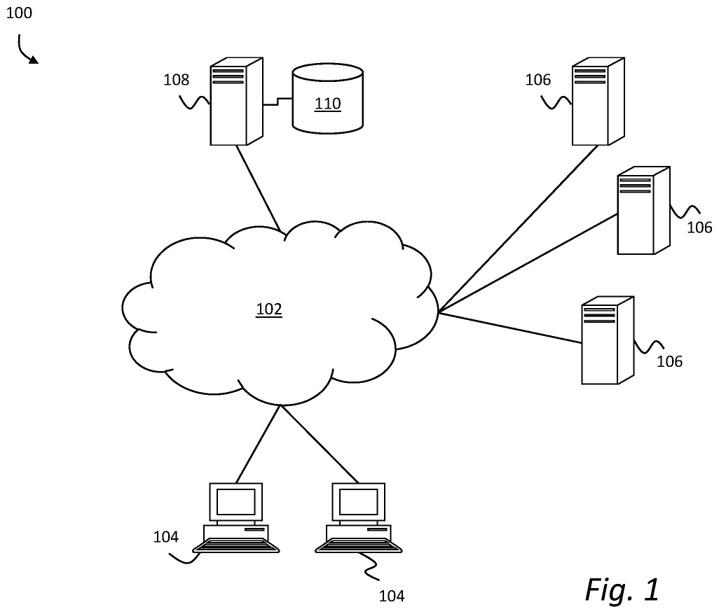

FIG. 1 shows entities participating in a ranking system. The system 100 may include a data network 102 such as the Internet that interconnects any number of clients 104, data sources 106, and a server 108 (which may include a database 110).

In general, the server 108 may coordinate the collection of comparative ratings from users by presenting a user interface that guides users (on clients 104) through side-by-side ratings of different items within a category of items. The server may also or instead present user rankings/ratings based on this collected data. For example, vehicles are commonly organized into categories such as sedans, sport utility vehicles, trucks, convertibles, hatchbacks, vans, minivans, wagons and so forth. These categories may be further subdivided into, e.g., compact vehicles, midsize vehicles, full-size vehicles, luxury vehicles, etc. These classes of vehicles may follow generally used industry categories, or they may be derived, e.g., from features or attributes of various vehicles within an actual or potential class of vehicle. Categories such as vehicle types may also or instead be subdivided by model year. A number of particular vehicles may be grouped within each category in order to support selections of vehicles for side-by-side comparisons during data acquisition, and presentation of vehicle rankings to users based on acquired data. Scoring for individual comparisons, as well as aggregated scores, rankings and other vehicle statistics, may be stored in the database 110 for use in subsequent calculations, or for communication to clients 104 for display.

The data network 102 may include any network or combination of networks suitable for interconnecting other entities as contemplated herein. This may, for example, include the Public Switched Telephone Network, global data networks such as the Internet and World Wide Web, cellular networks that support data communications (such as 3G, 4G and LTE networks), local area networks, corporate or metropolitan area networks, wide area wireless networks and so forth, as well as any combination of the foregoing and any other network or combination of networks suitable for data communications between the clients 104, the data sources 106 and the server 108.

The clients 104 may include any device(s) operable by end users to interact with the server 108 through the data network 102. This may, for example, include a desktop computer, a laptop computer, a tablet, a cellular phone, a smart phone, and any other device or combination of devices similarly offering a memory, a processor that can execute instructions from the memory, and a network interface collectively operable as a client device within the data network 102, or any other hardware and/or software suitable for operating as a client 104 as contemplated herein. In general, a client 104 may interact with the server 108 and locally render a user interface such as a web page or the like that supports interaction by an end user with services provided by the server 108.

The data sources 106 may include any sources of data useful for pricing/scoring as contemplated herein. In one aspect, this may include dealer listings, manufacturer information, consumer reviews, and so forth. Dealer listings may include information useful for price modeling or relevant to determination of a fair price for a particular vehicle including, without limitation, a vehicle type (e.g., make or model), a vehicle mileage, a vehicle year (of manufacture), a vehicle trim (e.g., option packages, features, etc.), a vehicle transmission, a vehicle condition, a vehicle interior/exterior color, a vehicle history (accident/repair history, rental fleet status, etc.) and so forth. Dealer listings may also be used to support vehicle purchases in the event that a user wishes to purchase a vehicle after viewing comparison data.

In another aspect, data sources 106 may include third party data providers. For example, a variety of commercial services are available that provide vehicle history such as a repair history, a fleet history (use in a rental fleet or commercial fleet of vehicles), a flood damage history, and so forth. Where data such as a vehicle identification number is available in dealer listings, such data may be directly matched to various listings. Other techniques can also or instead be used to correlate third party data to vehicle listings or otherwise infer vehicle condition or history. Other data such as data provided by government agencies may, where available, provide useful information relating to vehicle title, vehicle inspection history, vehicle mileage, vehicle accident history, and so forth. Any such data sources 106 may be used to support vehicle transactions, or to obtain summary statistics or data about vehicles that can be presented to users along with comparative data and rankings. In another aspect, the server 108 may aggregate consumer rankings, vehicle repair records, safety ratings, and so forth for presentation along with other data in side-by-side vehicle comparisons.

It will be understood that while a single server 108 is depicted in FIG. 1, any number of logical servers or physical servers may be used as the server 108 according to, e.g., server traffic, desired level of service, and so forth. Similarly, server functionality may be divided among different platforms in a number of ways. For example, one server or group of servers may be used to obtain data from the data sources 106 and create price models for various vehicle types. Another server or group of servers may be configured to provide a web interface for gathering scoring or comparison data from users, and/or to create ranking models as contemplated herein. Another server or group of servers may provide a client-facing interface for researching vehicles based on acquired comparison data and other data described herein.

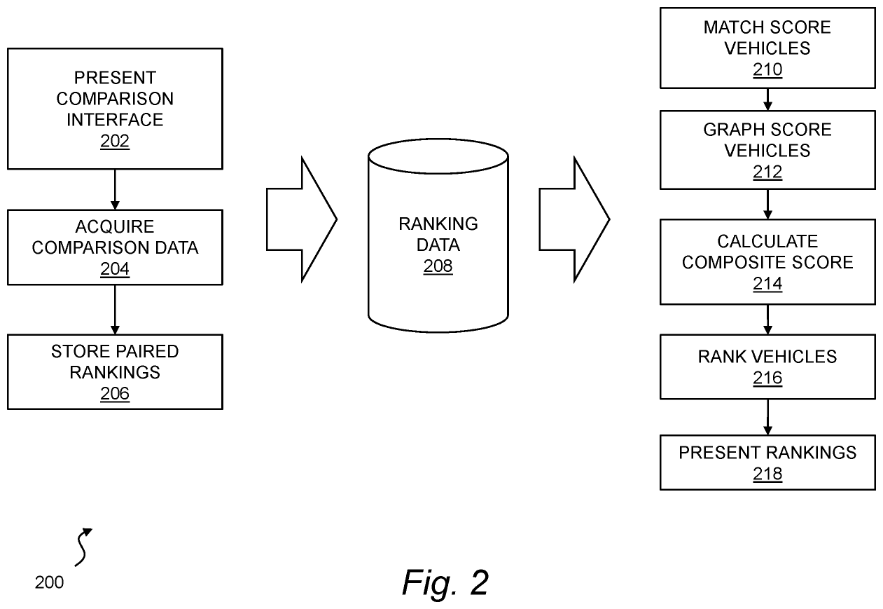

FIG. 2 is a flow chart of a method for comparing vehicles. In general, side-by-side comparisons are gathered on a feature-by-feature basis for a number of vehicles in a category and stored in a database of ranking data. This comparison data can be processed to derive rankings that advantageously provide more accurate predictions of relative vehicle preferences by consumers. As noted above, while the following description focuses on one useful application of these techniques—automotive vehicle comparisons—these techniques may be adapted to a wide range of consumer choices, and may more generally be used in any context where comparisons might be made among different items within a category or class of items.

As shown in step 202, the method 200 may include presenting an interface to a user. The interface may include a user interface presented with a web server or other server or the like to one or more remote computing devices over a data network. The interface may be a comparison user interface such as any of those described herein, e.g., for acquiring comparison data such as feature-by-feature comparisons of two similar vehicles from among three or more types of vehicles within a category of vehicles. For example, the user interface may display two different vehicles from a class or category of vehicles, in a side-by-side display that facilitates user selection of a preference for one vehicle or the other. Suitable categories of vehicles may include compact, mid-sized and/or full-sized. The categories may also or instead include one or more of truck, sedan, hatchback, sports car and sporty utility vehicle. More generally, any categories useful for sorting items into different types may be used as categories for selecting items for comparison as contemplated herein.

As shown in step 204, the method 200 may include acquiring comparison data. In one aspect, this may be an overall selection of one item versus the other, such as a preference of one vehicle over another. In another aspect, this may include feature-specific comparison data. For example, a user may be queried for relative ranking between vehicles based on any of a number of specific features such as power, handling, appearance, seating (size, comfort, etc.), cargo capacity, value, and so forth. Other subjective factors such as whether the car is a good family car, or whether the user would buy or recommend purchase of the vehicle, may also or instead be queried. After two items such as vehicles are selected for comparison, the user interface may display the items side by side within the user interface and walk a user through a series of such side-by-side, feature-specific comparisons.

It will be appreciated that comparison data may usefully be filtered or limited in this step. For example, the interface may be designed to limit, or attempt to limit, user feedback to comparisons for which a user has firsthand experience. For example, acquiring comparison data may include requesting a confirmation from the user that the user has owned or operated at least one of the two vehicles in a comparison before receiving the side-by-side scoring from the user. This filter may be applied to prohibit comparisons that are not based on firsthand experience, or to weight or de-weight particular comparisons based on the degree of direct, firsthand knowledge asserted by the user.

Additionally, comparison data may be gathered on an aggregate basis or a feature-specific basis, or some combination of these. For example, when two vehicles are presented for comparison, a user may be prompted to select a preferred vehicle overall, or to rank one vehicle higher with respect to a specific feature. In this latter approach, the user interface may guide a user through a number of specific features and request a preferred ranking for each feature. In one aspect, these feature-specific rankings may be aggregated into a composite ranking for a vehicle, such as a sum or weighted sum of the individual feature rankings, or the features may be used independently to calculate feature-specific rankings among vehicles. According to the foregoing, the method 200 may include acquiring comparison data by selecting two vehicles from among a number of vehicles in the category and presenting the two vehicles for side-by-side scoring by a user based on scoring for each of a number of features. More generally, any sequential, non-sequential, prompted, form-based or freeform technique for acquiring user comparison input based on one or more features may be used to acquire comparison data as contemplated herein.

It will also be understood that vehicle features may change from year to year, or they may stay the same. Thus a “similar” vehicle in this context may include a make or model of vehicle over two or more sequential years. In another aspect, a make and model of vehicle may migrate from one category to another due to a change in features from one year to the next. Thus, while it is generally contemplated that categories will be formed of makes and models of vehicles for a particular year, this is not a strict requirement. The categories may span multiple years, and particular types (e.g., makes and models) of vehicles may change categories from year to year. Similarly, a type of vehicle may change category based on trim level or the like, such as where a make and model of vehicle moves into a luxury category or a sports category based on a particular feature package offered by the manufacturer.

As shown in step 206, the method 200 may include storing paired rankings such as those gathered through the user interface described herein. For example, paired rankings may be stored as raw user input in a ranking data database 208, and may contain a set of paired rankings including a number of side-by-side scored evaluations received from users for a number of features. More specifically, this may include comparisons for pairs of vehicles selected from among vehicles within a class or category, such as three or more vehicles of different types within a category of vehicles. For example, the types of vehicles may include a number of makes and models of automobiles, and the category may be a category of vehicles that includes these different types (makes and models) of vehicles. It will be understood that a variety of weightings or other techniques may be used when combining groups of features to rank vehicles and/or calculate comparative scores. For example, a “would buy” preference may be accorded twice the weight of any other individual feature preference. However, in step 206, the method 200 may also or instead usefully include storing raw user input in order to facilitate more flexible downstream processing and analysis. More generally, the ranking data database 208 may store raw user input, processed user input, derivate scores, metrics or the like, and/or any other data or analytic results useful for comparing vehicles as contemplated herein.

As a significant advantage, gathering data in this manner avoids subjective scoring biases where, e.g., a consumer is asked to rate a vehicle, or a feature of a vehicle, on a numerical scale. Instead, users provide substantially binary selections between two specific choices. Each selection may be for a preferred vehicle overall, or for a specific preferred feature, or some combination of these. Rather than selecting an arbitrary numerical value, users can provide responses to specific queries about two side-by-side alternatives. As a result, each favorable or unfavorable response is anchored relative to a similar alternative, providing an implicit normalization to each user response.

As shown in step 210, the method 200 may include match scoring the vehicles relative to one another based on the data in the ranking data database 208. This may include scoring the vehicles using any match-based rating system, such as a system that provides a score predictive of a winner (or in this case, a consumer choice) in a head-to-head matchup based on prior results. In general, the comparison data in the ranking data database 208 may be processed as a time-based series of head-to-head matches, and the method 200 may include calculating a first score for one of the vehicles in one of the matches with a match-based rating system that incrementally adjusts the first score for a new match based on an opponent rating of the new match and an outcome of the new match. In a match-based scoring system, this first score may then provide a score predictive of an outcome for a new match between one vehicle in the category against other vehicles in the category, all based on a chronological history of match-based competition using the side-by-side scored evaluations in the ranking data database 208.

A variety of match-based scoring systems are known in the art and may be usefully employed with the method 200 described herein. For example, match scoring may use a match-based rating system such as the Elo rating system, or any other algorithm for incrementally adjusting a score for a new match based on the match opponent and the match outcome. The popular Elo rating system and derivative Elo-based techniques are used to calculate relative skill levels of players in games such as chess, and provides a predictor of an outcome in a hypothetical future match. A generalized Elo rating for a player i is updated using the formula:

rₜ′=rᵢ+K·(Sᵢ−Eᵢ) [Eq. 1]

where K is a scaling factor, Sᵢ is the outcome of a match (where Sᵢ={0,1} for binary outcomes such as a win or loss), and Eᵢ is the expected outcome. The expected outcome is further based on current player ratings for the player i and an opponent j using a formula such as:

$${E}_{i} = \frac{{10}^{( \frac{{r}_{i}}{400} )}}{{10}^{( \frac{{r}_{i}}{400} )} + {10}^{( \frac{{r}_{j}}{400} )}} \qquad [ Eq . 2 ]$$

There are numerous variations to the original Elo model based on, e.g., the expected distribution of player abilities and the sensitivity of the score to more recent events. The details of such match-based rating systems are known in the art, and are not repeated here in detail. While these techniques can provide good relative scoring in a manner specifically intended to predict future outcomes, they are also subject to certain limitations, particularly in a context such as vehicle rankings where there may be no reason to assume that a current side-by-side choice between two specific vehicles (e.g., make, model and year) is more accurate or useful than a one month old comparison or a one year old comparison. These difficulties are compounded where certain vehicles or certain vehicle pairs have relatively few user scores compared to others.

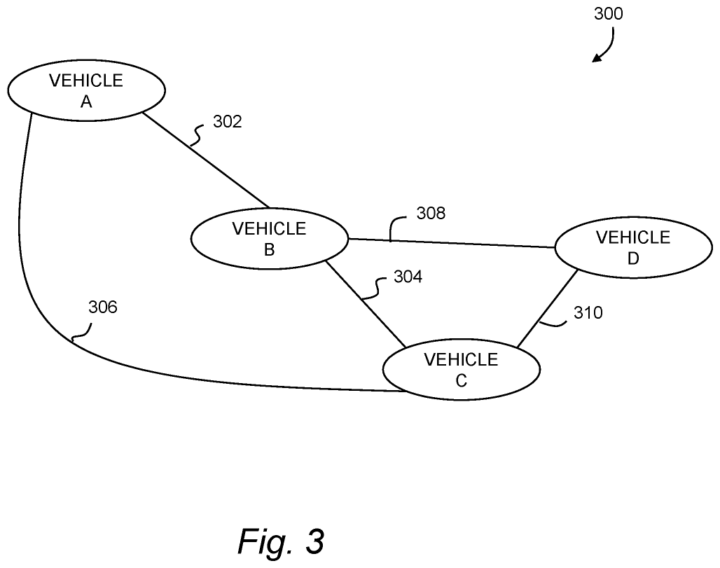

As shown in step 212, the method 200 may also include graph scoring the vehicles relative to one another by arranging the vehicles in a graph such as that shown below in FIG. 3 and calculating a second score for each vehicle based on wins and losses relative to other ones of the vehicles along a traversal of the graph.

In one aspect, this may include limiting a traversal of the graph to edges containing relevant comparison information, such as edges connecting vertices with monotonically increasing or decreasing outcomes along the graph. For example, assume that vehicle A is adjacent to vehicle B on the graph, and that vehicle A has more wins than losses against vehicle B. Further assume that a third vehicle, vehicle C, has a number of comparisons to vehicle A and vehicle B. In a monotonically limited scoring system, where vehicle A beats vehicle B, then the additional scores of vehicle B versus vehicle C will only be used to score vehicle A if vehicle B has also beaten vehicle C. This logically follows because, where vehicle A and vehicle C both beat vehicle B in head-to-head comparisons, it may be difficult or impossible to draw accurate inferences from these results about the relationship of vehicle A to vehicle C. Of course, where direct comparative information is available for vehicle A versus vehicle C, this may also or instead be used when calculating a graph-based score for vehicle A. Thus a score for a vertex may usefully consist of, i.e., be limited to, scores for other vertices with monotonically increasing or decreasing outcomes relative to the vertex for which the score is being calculated. In this context, the score for the vertex includes at least the score for each relevant vertex coupled by an edge to the vertex of interest.

In another aspect, traversal along the graph may be limited to a particular number of edge or degrees of separation. For example, a score may be calculated using vertices that are two degrees of separation or less within the graph. While two degrees of separation appears to provide useful and suitably-weighted comparison information, it will be understood that more or fewer degrees of separation may also or instead be used. For example, the score for a vertex may consist of scores for other vertices that are within one degree of separation, within two degrees of separation, within three degrees of separation, or some other number. One suitable formula for calculating vehicle scores may be in the form:

$$score = {\sum }_{1}^{n} 50 \frac{{( \frac{wins}{total} )}^{2.5} {log}_{10} ( total + 1 )}{separation} \qquad [ Eq . 3 ]$$

Where n is the number of edges available for scoring, e.g., after selecting vertices as described above, wins is the number, for one of the n edges, of wins between two associated vertices, total is the total number of comparisons for that edge, and separation is the degree of separation from the original vertex to the nearest vertex on the edge, where vertices at separation=1 are immediately adjacent to the starting vertex. It will be understood that, while the foregoing provides a useful formula for graph scoring vehicles, other graph scoring and evaluation techniques exist, and any other formula that similarly captures a quantitative evaluation of rank based on the number and arrangement of side-by-side comparisons may also or instead be used without departing from the scope of this disclosure. For example, losing comparisons may be subtracted from a score for a vertex, or may be ignored. In another aspect, edges may be excluded if the total number of comparisons is below a predetermined threshold, e.g., a minimum threshold selected to facilitate exclusion of statistically insignificant results.

This graph-based scoring technique does not have the recency bias of match-based rating systems. It may, however exhibit other biases such as sensitivity to differences in the number of comparisons available between each vertex pair. By combining these two systems—a match based scoring technique and a graph based scoring technique—a scoring approach can be devised that significantly mitigates the disadvantages of each, and advantageously provides relative scoring that is less sensitive to issues such as too many comparisons, too few comparisons, or the order/recency of particular comparisons.

As shown in step 214, the method 200 may include calculating a composite score based on a match score and a graph score for a vehicle. This may, for example, include normalizing or scaling the scores as appropriate, and calculating a composite score from a (non-zero) weighted combination of the match score and the graph score. It will be understood that the match based scoring system or the graph based scoring system may also or instead be used independently to compare vehicles, particularly in circumstances where the characteristic biases of each technique are reduced or minimized by the comparative data that is available. Thus in one aspect, a graph based scoring system may be used alone to compare vehicles. In another aspect, results may be shown for each of a graph based comparison, a match based comparison, and a composite comparison so that a user can review the contribution of each scoring technique to a final result and draw inferences as desired.

It will also be understood that a composite score may be calculated in a number of different ways. For example, a user may specify one or more specific features of interest, such as cargo space and handling, and the composite score may be calculated based exclusively on users' side-by-side rankings of these particular features. Thus in one aspect, the method 200 may include receiving a user selection of one or more selected ones of the number of features and calculating the composite score based on the selected ones of the number of features. In another aspect, the user may specify a group of two or more vehicles of interest, and the composite score may be calculated based exclusively for these vehicles, or exclusively based on side-by-side comparisons among these vehicles. For example, a user may be interested in four specific mid-sized sedans, and composite scores may be generated based on match scoring and graph scoring using only side-by-side comparisons among these four vehicles. Thus, the method 200 may include receiving a user selection of two or more of the vehicles, thereby providing user-selected vehicles, and calculating the composite score for each vehicle in the user-selected vehicles based exclusively on side-by-side comparisons between pairs of the user-selected vehicles.

Additionally, it should be appreciated that other scoring techniques may also or instead be integrated into a scoring system as contemplated herein, provided that these scoring techniques can, either individually or collectively, help to predict a consumer preference for an item on a feature-by-feature or aggregated basis. Thus, while a weighted combination of match scoring and graph scoring provide a demonstrably high quality indicator of likely consumer choices, a weighted combination may usefully integrate additional scoring techniques, e.g., to address other biases, compensate for sparse or unbalanced data, integrate data from other sources, or otherwise assist in drawing accurate inferences about consumer preferences based on explicit, feature-based feedback.

As shown in step 216, the method 200 may include ranking the vehicles or other items relative to one another based on the composite score calculated in step 214. As described above, it should be understood that ranking in this context may include an overall or aggregate ranking based on all of the features for which comparison data was acquired in step 204, or the ranking may include a ranking based on one or more user-selected features of interest.

As shown in step 218, the method 200 may include presenting the rankings, such as by displaying the vehicles or other items in an order ranked according to the composite score. For two items, the items may be presented side by side. For three or more different types of items, the items may be displayed in a list or other presentation format that otherwise visually conveys the ranked order based on the composite scores.

As noted above, the techniques describe herein may more generally be applied in any context where similar items might usefully be compared on an aggregate or feature-by-feature basis. Thus in one aspect, a method disclosed herein includes storing a set of paired rankings including a number of side-by-side scored evaluations of a number of features by users of pairs of items from among items including three or more different types of items within a category of items; match scoring the items relative to one another using a first score based on a match-based rating system that provides a score predictive of an outcome for a match between one item in the category against other items in the category according to a chronological history of match-based competition based on the number of side-by-side scored evaluations; graph scoring the items relative to one another using a second score based on a graph of the items and the number of side-by-side scored evaluations; calculating a composite score for each of the items from a weighted combination of the first score and the second score; and ranking the items based on the composite score.

In another aspect, a system implementing any of the foregoing methods may include a server such as any of the servers described herein coupled in a communicating relationship with a data network, a processor on the server, and a memory on the server storing instructions executable by the processor. The instructions may more specifically configure the server to perform the steps of storing a set of paired rankings including a number of side-by-side scored evaluations of a number of features by users of pairs of vehicles from among vehicles including three or more different types of vehicles within a category of vehicles; match scoring the vehicles relative to one another using a first score based on a match-based rating system that provides a score predictive of an outcome for a match between one vehicle in the category against other vehicles in the category according to a chronological history of match-based competition based on the number of side-by-side scored evaluations; graph scoring the vehicles relative to one another using a second score based on a graph of the vehicles and the number of side-by-side scored evaluations; calculating a composite score for each of the vehicles from a weighted combination of the first score and the second score; and ranking the vehicles based on the composite score, thereby providing vehicle rankings.

The processor may be further configured to perform any of the alternative or additional steps described herein. For example, the processor may be further configured by computer executable code to communicate the vehicle rankings for display to one or more other devices coupled to the server through the data network. In another aspect, the processor may be configured by computer executable code to receive the set of paired rankings as input from users on one or more other devices coupled to the server through the data network. The match-based rating system may include an algorithm for incrementally adjusting the first score for a new match based on an opponent rating of the new match and an outcome of the new match, and the second score for graph scoring a vertex of the graph representing one of the vehicles may consist of a sum of scores for other vertices of the graph that are two degrees of separation or less within the graph and that have monotonically increasing or decreasing outcomes relative to the vertex.

FIG. 3 shows a graph for scoring vehicles. In general, a score for vehicle A may be calculated using the scores for some or all of the edges in the graph 300 connected to the comparison target. For example, a score for the first edge 302 may be calculated based on a win/loss record versus vehicle B, e.g., using the graph scoring formula described above or any other suitably sensitive and suitably scaled formula for use in combination with a match-based scoring algorithm as contemplated herein. If the first edge 302 ranks vehicle A above vehicle B, then any second degree vertices for which vehicle B similarly ranks above an adjacent vehicle may also be used to calculate the score for vehicle A. For example, if vehicle B ranks above vehicle C along a second edge 304, then the score for the first edge and the second edge 304 may be included in a graph score for vehicle A, adjusted as appropriate for the degree of separation from vehicle A within the graph 300. Similarly, where direct comparison data is available between vehicle A and vehicle C, e.g., along a third edge 306, a score for this third edge 306 may also or instead be calculated and included within a graph-based score for vehicle A. Thus it will be noted that vehicle C may be concurrently at one degree of separation and two degrees of separation from vehicle A, and the second edge 304 may optionally be used in or omitted from a calculation of a graph score for vehicle A. More generally, whether a particular edge of the graph 300 is used to calculate the score for vehicle A may depend on any number of factors, such as the degrees of separation from the vehicle for which a score is being calculated, the win/loss nature of sequential edges along the graph 300, and whether other, more direct information (such as a closer edge) is available.

Vehicle D may have comparison data with vehicle B and vehicle C, as illustrated on the graph 300 by a fourth edge 308 and a fifth edge 310, respectively. Provided the result along edge 308 follows a monotonically increasing or monotonically decreasing outcome to the first edge 302, then the score of the fourth edge 308 may be included in a graph-based score for vehicle A. Where only two degrees of separation are included in the calculation, however, the fifth edge 310 would not be included in a score for vehicle A even when specifically comparing vehicle A to vehicle D, and even if the fifth edge 310 follows a similar monotonically increasing or decreasing outcome as the intervening edges 302, 304.

In practice, a graph may have numerous additional vertices representing numerous additional vehicles (or other items), along with numerous additional edges representing side-by-side comparisons that have been scored by users. Thus, while four vertices and five edges are shown, any number of edges and vertices may be used to rank items within a category as contemplated herein.

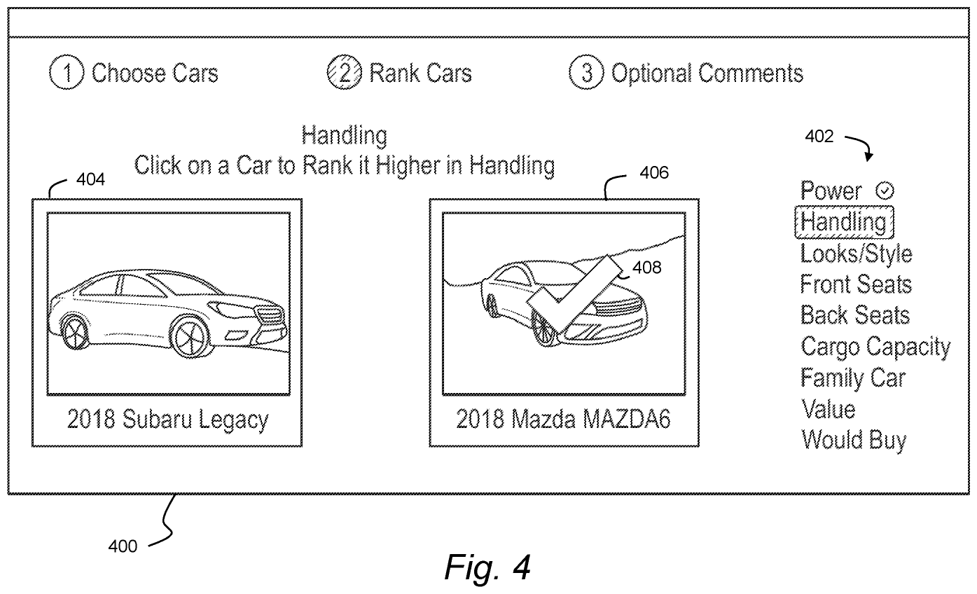

FIG. 4 shows a web page for acquiring comparison data. The web page 400 may be transmitted from a server such as any of the servers described above to a client for local display. The web page 400 may include a pair of vehicles or other items displayed side by side to a user. The web page 400 may also display a number of features 402, and may guide a user through side-by-side selections of one vehicle 404 versus another vehicle 406 for each feature. For example, a user may click on or otherwise identify a higher ranked one of the vehicles (illustrated in FIG. 4 as a check mark 408 over the selected vehicle 406) with respect to a current one of the number of features 402. The web page 400 may respond to such a selection by automatically advancing to the next one of the number of features 402, or the web page 400 may request a confirmation or other user input before proceeding. In another aspect, the web page 400 may facilitate freeform navigation among the number of features 402 so that a user can proceed in any desired order, and/or review previous selections before finalizing a comparison.

The web page 400 may also include a variety of tools for navigating within the comparison process, confirming choices, requesting additional information, and so forth. While the web page 400 illustrated in FIG. 4 provides a useful interface for receiving user comparisons, it will be understood that any other visual, textual or other techniques may also or instead be used to guide a user through a side-by-side, feature-by-feature comparison or otherwise receive comparative input from a user.

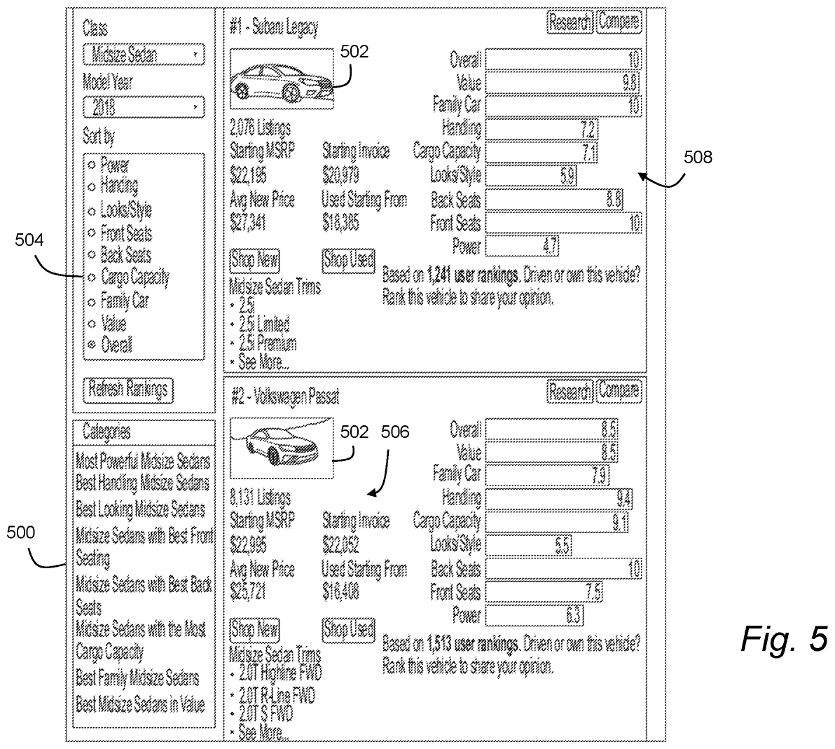

FIG. 5 shows a web page for presenting ranked results. In general, the web page 500 may show items such as a number of vehicles 502 ranked based on the scoring techniques described herein. While an overall ranking may be provided, the web page 500 may also or instead permit a user to select one or more of the comparison features 504 for use in scoring and ranking the vehicles. While any features might be included in this list of comparison features 504, certain features most likely to be interesting or useful to consumers may preferentially be included. Common features for comparison among vehicles include power, handling, looks/styling, front seats, back seats, cargo capacity, family car, and value. The web page 500 may also present other information of actual or potential interest to a user, such as additional vehicle information 506, e.g., price, engine size, fuel economy, trim levels and other manufacturer data and the like. The web page 500 may also or instead display summary information 508 from side-by-side comparisons such as feature-by-feature scores or results, ranking metadata (e.g., number of rankings) and so forth.

The web page 500 may also or instead present various tools, controls and the like for navigating among ranked items, selecting new vehicle categories, performing additional research on selected vehicles, shopping for vehicles and so forth. More generally, any information, navigational tools, research tools and the like that might assist a user in searching for, comparing, and/or purchasing vehicles may usefully be incorporated into the web page 500 described herein.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors, or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

It should further be appreciated that the methods above are provided by way of example. Absent an explicit indication to the contrary, the disclosed steps may be modified, supplemented, omitted, and/or re-ordered without departing from the scope of this disclosure.

The method steps of the invention(s) described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps.

While particular embodiments of the present invention have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A computer program product comprising non-transitory computer executable code embodied in a computer readable medium that, when executing on one or more computing devices, performs the steps of:
storing a set of paired rankings including a number of side-by-side scored evaluations of a number of features by users of pairs of vehicles from among vehicles including three or more vehicles of different types within a category of vehicles;
match scoring the vehicles relative to one another using a first score based on a match-based rating system that incrementally adjusts the first score for a new match based on an opponent rating of the new match and an outcome of the new match to provide a score predictive of an outcome for a match between one vehicle in the category against other vehicles in the category based on a chronological history of match-based competition using the number of side-by-side scored evaluations;
graph scoring the vehicles relative to one another by arranging the vehicles in a graph and calculating a second score for each vehicle based on wins and losses relative to other ones of the vehicles along a traversal of the graph to any vertices with monotonically increasing or decreasing outcomes, using vertices of the graph that are two degrees of separation or less within the graph;
calculating a composite score for each of the vehicles from a non-zero weighted combination of the first score and the second score; and
ranking the vehicles relative to one another based on the composite score.

2. The computer program product of claim 1 further comprising code that performs the step of selecting two vehicles from among a number of vehicles in the category and presenting the two vehicles for a side-by-side scoring by a user based on scoring for each of a number of features.

3. The computer program product of claim 2 further comprising code that performs the step of requesting a confirmation from the user that the user has owned or operated at least one of the two vehicles before receiving the side-by-side scoring from the user.

4. A method comprising:
storing a set of paired rankings including a number of side-by-side scored evaluations of a number of features by users of pairs of items from among items including three or more different types of items within a category of items;
match scoring the items relative to one another using a first score based on a match-based rating system that provides a score predictive of an outcome for a match between one item in the category against other items in the category based on a chronological history of match-based competition using the number of side-by-side scored evaluations;
graph scoring the items relative to one another using a second score based on a graph of the items and the number of side-by-side scored evaluations;
calculating a composite score for each of the items from a weighted combination of the first score and the second score; and
ranking the items based on the composite score.

5. The method of claim 4 wherein the items are vehicles including three or more types of vehicles within a category of vehicles.

6. The method of claim 5 wherein the category includes one or more of compact, mid-sized and full-sized.

7. The method of claim 5 wherein the category includes one or more of truck, sedan, hatchback, sports car and sporty utility vehicle.

8. The method of claim 5 further comprising selecting two vehicles from among a number of vehicles in the category and presenting the two vehicles for side-by-side scoring by a user based on scoring for each of a number of features.

9. The method of claim 8 further comprising requesting a confirmation from the user that the user has owned or operated at least one of the two vehicles before receiving the side-by-side scoring from the user.

10. The method of claim 5 further comprising receiving a user selection of one or more selected ones of the number of features and calculating the composite score based on the selected ones of the number of features.

11. The method of claim 5 further comprising receiving a user selection of two or more of the vehicles, thereby providing user-selected vehicles, and calculating the composite score for each vehicle in the user-selected vehicles based exclusively on side-by-side comparisons between pairs of the user-selected vehicles.

12. The method of claim 4 wherein the match-based rating system includes an Elo rating system.

13. The method of claim 4 wherein the match-based rating system includes an algorithm for incrementally adjusting the first score for a new match based on an opponent rating of the new match and an outcome of the new match.

14. The method of claim 4 wherein the second score for a vertex of the graph representing one of the items consists of scores for other items of the graph that are two degrees of separation or less within the graph.

15. The method of claim 4 wherein the second score for a vertex of the graph representing one of the items consists of scores for other vertices with monotonically increasing or decreasing outcomes relative to the vertex.

16. The method of claim 4 further comprising displaying the three or more different types of items in an order ranked according to the composite score.

17. A system comprising:
a server coupled in a communicating relationship with a data network;
a processor on the server; and
a memory on the server, the memory storing instructions executable by the processor to perform the steps of storing a set of paired rankings including a number of side-by-side scored evaluations of a number of features by users of pairs of vehicles from among vehicles including three or more different types of vehicles within a category of vehicles; match scoring the vehicles relative to one another using a first score based on a match-based rating system that provides a score predictive of an outcome for a match between one vehicle in the category against other vehicles in the category based on a chronological history of match-based competition using the number of side-by-side scored evaluations; graph scoring the vehicles relative to one another using a second score based on a graph of the vehicles and the number of side-by-side scored evaluations; calculating a composite score for each of the vehicles from a weighted combination of the first score and the second score; and ranking the vehicles based on the composite score, thereby providing vehicle rankings.

18. The system of claim 17 wherein the processor is further configured by computer executable code to communicate the vehicle rankings for display to one or more other devices coupled to the server through the data network.

19. The system of claim 17 wherein the processor is further configured by computer executable code to receive the set of paired rankings as input from users on one or more other devices coupled to the server through the data network.

20. The system of claim 17 wherein the match-based rating system includes an algorithm for incrementally adjusting the first score for a new match based on an opponent rating of the new match and an outcome of the new match, and further wherein the second score for graph scoring a vertex of the graph representing one of the vehicles consists of a sum of scores for other vertices of the graph that are two degrees of separation or less within the graph and that have monotonically increasing or decreasing outcomes relative to the vertex.
